(19) United States
(12) Patent Application Publication
(10) Pub. No.: US 2026/0093261 A1
(43) Pub. Date: Apr. 2, 2026

(54) ROBOTICS WORKLOAD MANAGEMENT AND FAILURE MITIGATION

(71) Applicant: Intel Corporation, Santa Clara, CA (US)

(72) Inventors: Florian MIRUS, Eppelheim (DE); Frederik PASCH, Karlsruhe (DE)

(21) Appl. No.: 19/307,092

(22) Filed: Aug. 22, 2025

(30) Foreign Application Priority Data
Sep. 27, 2024 (DE) 10 2024 128 140.5

(51) Int. Cl. G05D 1/622; G05B 13/02; G05D 101/15

(52) U.S. Cl. CPC G05D 1/622; G05B 13/027; G05D 2101/15

(57) ABSTRACT

A server may include an interface that is configured to receive sensor data related to a cyber-physical system (CPS); and a processor. The processor may be configured to determine a performance parameter of the CPS from the sensor data; select a resource allocation strategy based on the performance parameter; execute an algorithmic process on at least a portion of the sensor data according to the resource allocation strategy; and control a transmitter to send data representing an output of the executed artificial neural network to the robot.

### CROSS-REFERENCE TO RELATED APPLICATIONS

This non-provisional patent application claims priority to German patent application 10 2024 128 140.5, filed on Sep. 27, 2024, the entire contents of which are hereby incorporated by reference.

### BACKGROUND

Robots are deployed in a variety of environments and may be required to execute diverse and/or computationally complex tasks that may require significant resources for their completion. One related trend is the introduction of artificial intelligence (AI) to improve robots' performance of tasks. That is, AI may permit robots to perform complicated tasks or tasks at a higher level of abstraction, operate with a greater degree of accuracy or precision, or otherwise expand the functional capacity of the robot. Such AI-based computations, and even various complex non-AI-based workflows, may require significant computational resources or electrical power.

Robots, especially mobile robots, however, have limited resources. Robots may typically rely on batteries for power, thereby limiting their power resources. For practical reasons such as cost-concerns, robots may operate with limited processing capability (e.g. a limited central processing unit (CPU) and/or graphics processing unit (GPU)), limited memory, or the like. As such, it is not always desirable or practical for robots to be locally equipped with the magnitude of computational or battery resources that may be necessary for performance of computationally-demanding tasks, let alone AI-based computational tasks.

In light of this, it may be desirable for one or more robots in a fleet of robots to offload some or all of their computationally demanding tasks to an edge processing resource like a server or a cloud processing resource like a server, which may permit resource-limited robots to leverage the massive computing power that may be available in a remote processing resource like a server. However, given a robot fleet in which the computational complexity of the robots' various tasks, and even the hardware capabilities of the robots themselves, may vary dramatically, it may be desired to determine how to allocate available compute resources (e.g., resources in the edge server or the cloud), and how to mitigate application failures to minimize the failure's impact on the robots' and fleets' task performance.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 depicts a high-level overview of the resource management strategies disclosed herein;

FIG. 2 depicts another abstraction of the resource management strategies disclosed herein;

FIG. 3 depicts an example for task-aware workload handling;

FIG. 4 depicts behavior-aware workload handling according to an aspect of the disclosure;

FIG. 5 depicts an example for safety-focused workload handling;

FIG. 6 depicts a hierarchical monitoring approach;

FIG. 7 depicts a visualization of the behavior tree representation of the mobile manipulator example;

FIG. 8 depicts an example of behavioral monitoring;

FIG. 9 depicts a safety-focused monitoring system;

FIG. 10 depicts key performance indicator (KPI) optimization according to an aspect of the disclosure;

FIG. 11 depicts behavior-aware resource optimization according to an aspect of the disclosure;

FIG. 12 depicts an example of task-dependent resource optimization;

FIG. 13 depicts a comparison of failure recovery approaches in order of their restart time;

FIG. 14 depicts various handover approaches; and

FIG. 15 depicts a server.

### DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as radiofrequency (RF) transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

Throughout this disclosure, the term “cyber-physical system” (CPS) is used. A CPS may be generally understood as an integration of computer computation (e.g., processing of computer instructions, performance of computer algorithms, implementation of an artificial neural network, etc.) with one or more physical processes (e.g., movement of a robotic arm or actuator, engagement of a motor for transport or locomotion, etc.). In CPSs, physical and software components may be able to operate on different spatial scales, such as existing in different physical locations (e.g., an edge server in a first location and a robotic arm in a second location). The physical and software components may exist in different temporal scales, wherein some execution of software instructions may occur non-contemporaneously with the execution of a corresponding physical action. The interaction of physical and software components of a CPS may be dictated by behavioral modalities, which may change with context. Whereas a CPS as described herein is intended to include a robot, a CPS may be broader than a robot as understood in a conventional sense. That is, a robot may, in some contexts, be understood to connote both computational processing and physical processes in a single unit (e.g., an autonomous or semi-autonomous pallet-mover, an autonomous or semi-autonomous vacuum, etc.). In the context of a CPS, however, at least some of the processing may be separated from the portion of the CPS that physically interacts with its surroundings. This processing may optionally further be separated among multiple sources (e.g., among one or more edge servers, one or more cloud servers, etc.). Such distributed processing may be orchestrated, such as through an orchestrator, which may separate (e.g., containerize) one or more processes and/or may designate one or more resources for the performance of any one or more cognitive tasks. Various forms of task orchestration are known and the specifics of which will not be discussed herein. Rather, attention will be drawn to the process of selecting or designating resources (e.g., processing resources such as CPUs, GPUs, and the like; memories; artificial neural network models of differing numbers of parameters, etc.) for performance of computational functions within the context of a CPS. The term CPS, as used herein, is primarily directed to at least one processing or computational entity (e.g., a server), which performs one or more computational operations for a physical device that is configured to interact with its surroundings (e.g., a robot).

The term “algorithmic process” as used herein is expressly intended to include processes performed using conventional programming instructions (e.g., conventional code to cause a processor to perform computations according to a series of steps) and/or execution of one or more artificial neural networks (ANNs). That is, algorithmic processes, as used herein, may be understood as referred into computational processes in a conventional algorithmic function, execution of an ANN, or both.

A system, device, and method for hierarchical monitoring, dynamic resource management, and failure mitigation is presented herein. These principles and methods take into account the unique challenges of distributed robotics applications by monitoring metrics and applying robotic-centric resource allocation optimizations and failure mitigations.

In the context of cloud-native applications, it is known to allocate and manage workloads; however, existing approaches are not directly applicable to robotics applications, which include interactions with the physical world, asynchronous and only partially active workloads, and diverse requirements and deployments. Similarly, for the problem of mitigating application failures, existing solutions for cloud-native applications are generally insufficient for robotics applications, where additional approaches for problems such as failure detection, state monitoring, handover, and safety are necessary.

In the following, a solution for dynamic resource management and mitigation of failures for robotic workloads within computing clusters in the edge or cloud is proposed. At its core, a monitoring system lays the foundation for task-management, behavior-management, and safety-aware resource management. The monitoring system may include a state-preserving failure mitigation approach. By incorporating robotic-specific metrics, such as physical behavior, safety considerations, and current mission parameters or performance requirements, the principles and methods disclosed herein may enable a cost-effective, high performance, economic and reliable robot and robot-fleet operation in an edge or cloud environment while ensuring safety and high availability. The principles and methods disclosed herein may reduce costs for robotics applications in an edge-server or cloud-server, close the gap between the reliability of on-board and distributed robotics applications, and may generally represent a solution that can be used in any type of cyber-physical system. The principles and methods disclosed herein may include or enable task-awareness. In this manner, missions of heterogeneous robots or robot fleets may be considered in resource management.

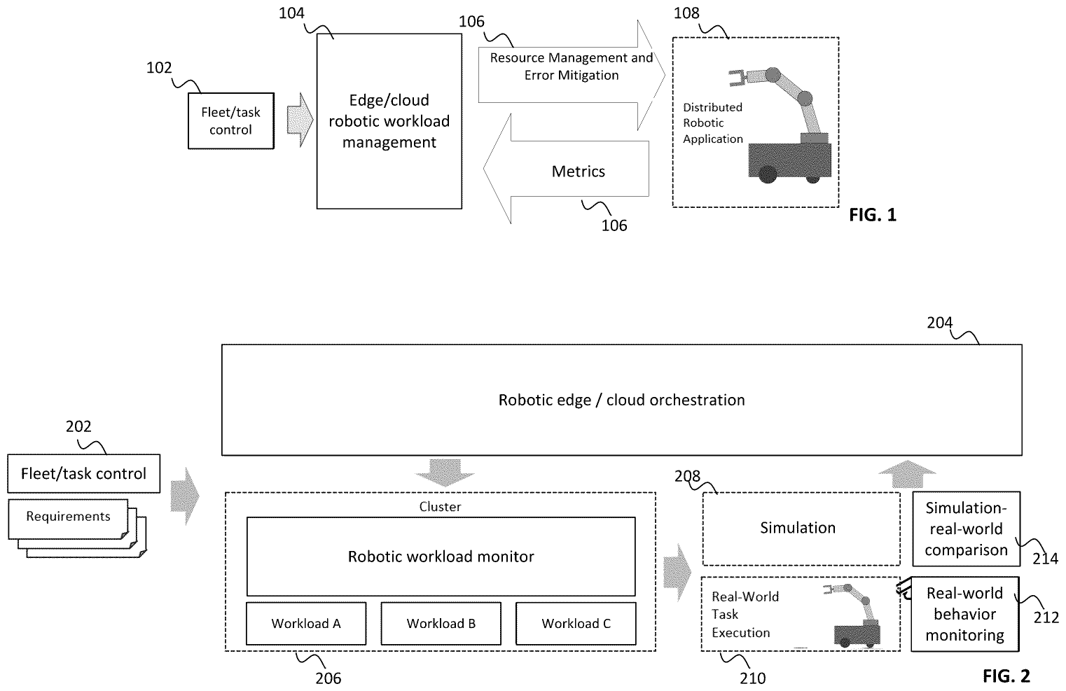

FIG. 1 depicts a high-level overview of the resource management strategies disclosed herein. In this manner, a fleet of robots will be managed by a fleet/task controller 102, which may be implemented in software or hardware, and which may be a standalone unit or part of any other unit described herein, such as part of an edge server or a cloud server. The fleet/task controller 102 may include, or provide information to, an edge/cloud robotic workload manager 104, which may also be implemented in software or hardware, and may be a standalone unit or part of any other unit described herein. The edge/cloud robotic workload manager 104 may receive metrics 106 (e.g., robot-specific metrics), which may broadly be any robot metric, but may include, for example, key performance indicators (KPIs), robot speed, robot latency, robot error or failure rate, or the like. Given the metrics (note that the decision making may be based on the metrics alone or on the metrics in combination with any other factor as will be described in greater detail herein), the edge/cloud robotic workload manager 104 may add, subtract, and/or change resources available to one or more robots (this decision process is represented abstractly as 106 and refers to one or more) and may apply those new resources to one or more robots in a distributed robot application 108.

FIG. 2 depicts another abstraction of the resource management strategies disclosed herein. In this figure, the fleet or task controller 202 may operate in conjunction with the robotic workload monitor cluster 206. This robotic workload monitor cluster 206 may include a robotic workload monitor that may be configured to monitor various workloads of one or more robots, which are depicted herein, for example, as workload A, workload B, and workload C (the underlying concept is not limited to three workloads; three workloads are used herein merely for demonstrative purposes). As an alternative to, or in addition to the assignment of resources based on metrics (e.g., KPIs, etc.), the resource management strategies may be configured to assign resources based on a comparison of real-world performance with simulated performance. In this manner, and for any given task, a simulation 208 of the robot performance under idealized conditions may be generated. For example, and for a given robot performing a perception task, the system may simulate the robot's performance of the perception task, such as under ideal conditions, given maximum resources, or any other magnitude of resources than that which the workflow is currently assigned. When the robot executes the task in the real-world 210, the system may monitor the robot's real-world behavior 212. The system may then be configured to compare 214 the simulated task performance with the real-world task performance. Based on the results of this comparison, the system may be configured to add, remove, or change available resources for the robot to perform the task. Such changes may be performed within the robotic edge/cloud orchestrator 204. In performing either of the strategies disclosed herein (e.g., evaluation based on metrics, evaluation based on simulation), it is possible to perform at-runtime monitoring of robotic workloads running in a distributed edge-/cloud-deployment, to facilitate efficient, task-aware resource management, and to perform application failure mitigation with state preservation and different criticality levels.

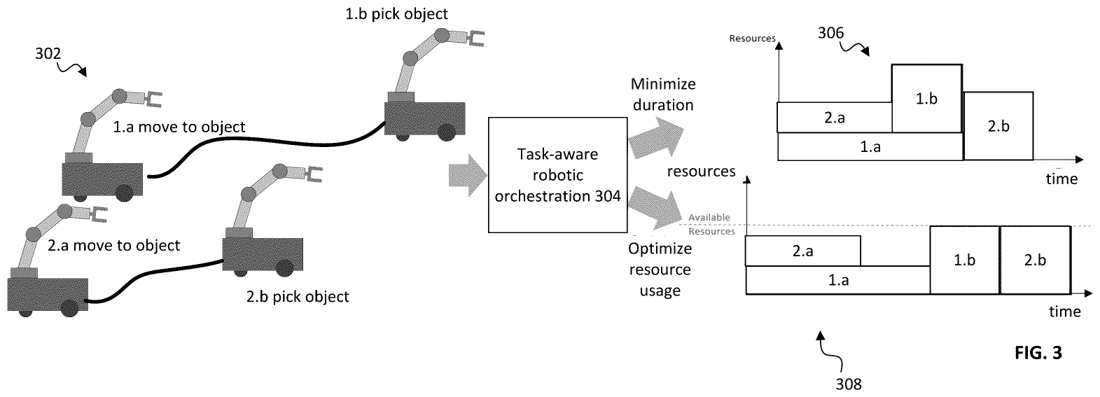

FIG. 3 depicts an example for task-aware workload handling. In this figure, the high-level task is for mobile manipulation robots to move somewhere and pick up objects (see, generally, 302, depicting the robot moving to the object and picking it up), and this task results in a duration-minimized and/or a resource-limited schedule. That is, the task aware robot orchestrator 304 may assign resources for the robot's task, and this assignment may be selected with the aim of satisfying any of a variety of goals. For example, as depicted in 306, the resources may be selected to minimize duration of the task. As can be seen in 306, a greater number of resources are used in parallel, thereby limiting the overall duration of the task. In contrast, the task aware robotic orchestrator 304 may opt to assign resources such that resource usage is optimized 308, which may result in fewer resources being used in parallel, which may thus extend the overall time for task completion. By monitoring the behaviors of the robots, for example by monitoring workload input and/or workload-output and/or additional external methods like object detection and tracking (e.g., using robot-attached or external cameras), the orchestrator may manage the resources and/or mitigate failure.

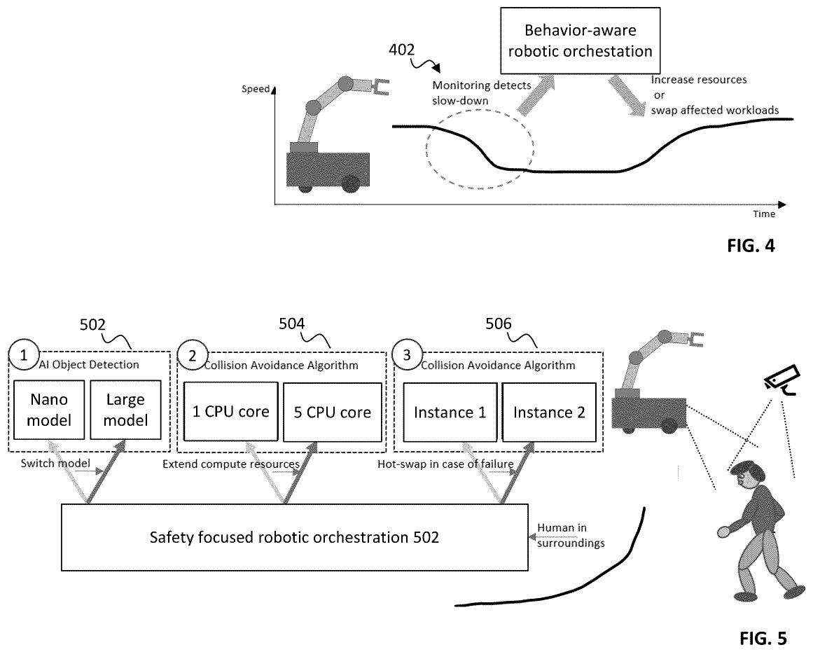

FIG. 4 depicts behavior-aware workload handling according to an aspect of the disclosure. That is, a mobile robot performing a given task may be expected to move at a certain speed. One or more monitors may detect (e.g., from video or other sensor information), or determine (e.g., receive a speed, such as through a transmission) a speed of the robot and determine that this requirement is not fulfilled. In response, the orchestrator may execute one or more countermeasures, such as by providing more resources or swapping a workload.

The principles and methods disclosed herein may be performed with a focus on safety. That is, the avoidance of human harm may and/or the avoidance of property damage may be considered of paramount importance in resource management and/or failure mitigation. FIG. 5 depicts an example for safety-focused workload handling. In this manner, the system may consider one or more safety factors and may make decisions about resource usage in order to improve overall safety. Although a variety of safety factors are conceivable, one simplistic safety factor may be whether a human is within a vicinity of a robot. That is, if a human is not within a vicinity of a robot, then injury to the human is unlikely. However, once a human comes within a vicinity of the robot, it may be necessary to improve overall safe operation of the robot to ensure human safety. In this manner, the safety-focused orchestrator 502 may make one or more decisions to improve overall safety. Such decisions may include, but are not limited to, switching from a small model to a large model (e.g., switching from an artificial intelligence (AI)-model with fewer parameters to an AI-model with greater parameters), increasing a number of cores (e.g. CPU cores, GPU cores) available for processing 504, switching among algorithm instances (e.g. when multiple instances of an algorithm are executed redundantly, switching from one instance to another instance, such as based on improved results of one instance over another instance) 506, or any of these.

In the above, various approaches to selecting resources for a computational task have been described, and, in particular, with respect to the satisfaction of KPIs, by comparing an actual performance of the robot to a simulated performance, based on a particular task that the CPS is performing or scheduled to perform, whether the robot is operating within a vicinity of a human, a frequency of robot errors, or a frequency or severity of task failures. Each of these may be considered a performance parameter for the purposes of this disclosure. In this manner, the server of the CPS may be configured to select a resource allocation strategy based on one or more of these performance parameters. The server may derive the performance parameter from sensor data, whether sensor data from a robot, sensor data from a source external to the robot (e.g. from another robot, from a sensor in a room or otherwise within a vicinity of the robot, etc.). Alternatively or additionally, the server may determine the performance parameter from one or more general performance policies. These general performance policies may be or include a number of tasks to successfully perform in a given period, an acceptable latency, an acceptable speed, an acceptable error quote/rate, etc.

As used throughout, sensor data may be or include raw sensor data, or the data that results after raw sensor data has been processed in some manner. For example, the sensor data may be or include raw sensor data has have undergone a filtering process, such as to reduce noise, change bandwidth, or otherwise. The sensor data may be or include data derived from sensor data. For example, and assuming hypothetically that a relevant sensor is an image sensor, the sensor data may be pixel data (e.g., color, hue, luminescence), feature data (e.g., features that have been identified by the pixel data), predictions of picture contents, bounding boxes, occupancy grids or otherwise. Where the sensor data may be or include a determination from one or more sensors that the robot is in a vicinity of a human. The sensor data may be or include a determination of task successes or task failures, robot latency, speed, or otherwise. In summary, the term “sensor data” as used throughout should not be understood as being limited to raw sensor data, but can otherwise include any data or determinations that are made from raw sensor data.

The resource allocation strategy may refer at least to the selection of computational resources, memory, or artificial neural networks for the performance of a task. That is, the resource allocation strategy may include increasing or decreasing a number of CPUs available for performance of a task (e.g. for a workload), increasing or decreasing a number of GPUs available for performance of a task (e.g. for a workload), increasing or decreasing a number memories or a quantity of memory storage available for performance of a task (e.g. for a workload), or selecting an artificial neural network from a plurality of artificial neural networks for performance of a computational task.

Once the processor selects the resource allocation strategy, the processor may implement or cause to be implemented the computations (e.g., the workload). The computations or workload will result in an output. The server may cause the output to be transmitted (e.g., via a wireless transmitter) to the robot. In some circumstances, it may not be desirable to send the results of the computations or workload directly in a transmission (e.g., in raw format), and therefore the server may alternatively send data or instructions representing or derived from the computations or workload. For example, in a navigation planning workload, the workload may output a path of travel. The server, however, may cause to be transmitted the path of travel, a destination, detailed movement instructions to cause the robot to move along the path of travel or otherwise.

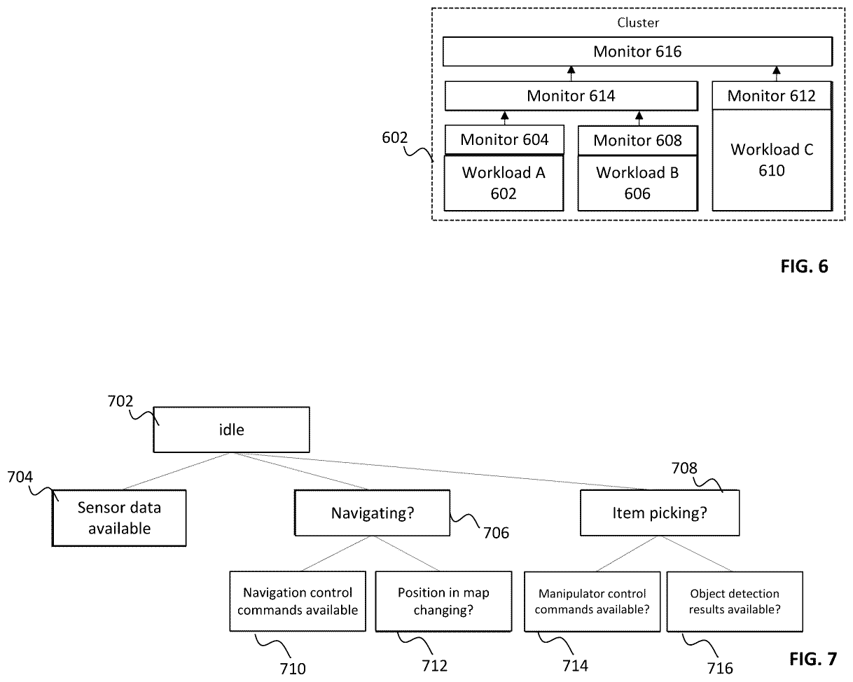

According to an aspect of the disclosure, the principles and methods disclosed herein may operate using a hierarchical monitoring system. Application-monitoring and workload-monitoring may be key ingredients in ensuring meaningful and functional operation of edge-systems and/or cloud-systems. However, in a cloud-native deployment, containers are typically isolated from the physical world and are often separated from each other. However, for complex robotic systems, software modules and algorithmic workloads may form an interconnected and hierarchical system where processes may not only be connected to each other, but they may also depend on each other. For instance, consider a navigation system for an autonomous mobile robot (AMR), in which the components responsible for path planning and trajectory following are highly dependent on components implementing the robot's self-localization such as adaptive Monte-Carlo localization (AMCL) or simultaneous localization and mapping (SLAM). Hence, the monitoring system may need to be aware of this hierarchical connection within the robotic system at hand to properly react to changes and/or failures in the system. Therefore, the proposed monitoring system itself consists of a hierarchy of multiple components that either monitor individual workloads directly, or monitor the system at a higher level while taking connections and dependencies of algorithmic components into consideration. FIG. 6 depicts such a hierarchical monitoring approach. For example, a server executing a navigation operation for a robot may be required to perform at least two workloads, which will be referred to as workload A 602 and workload B 606, and which may illustratively refer to robot localization and path planning modules respectively. Each of these must generally be monitored individually. Each of these workloads may include its own monitor, that may be configured to monitor the health or performance of the particular workload. For example, workload A 602 may be directly monitored by monitor 604, and workload B 606 may be directly monitored by monitor 608. These monitors may include software that may be configured to carry out instructions to monitor the performance of the corresponding workload. Any monitor may be executed in software or hardware. The monitor may be configured to receive sensor data, or processor data/statistic to perform its monitoring function.

A failure of localization in workload A 602 may negatively affect the path planning of workload B 606 (e.g., the workflows may be interrelated or interdependent), so the monitor 614 (e.g. a high-level monitor that can monitor multiple workflows) takes this dependency into consideration to bring the overall system back to a healthy and functional state. In an optional configuration, additional high-lever monitors may be present, which may be configured to monitor multiple workloads, and even other monitors of other workloads. For example, workload C 610, which may be a workload configured to execute any function for the purposes of this example, may be directly monitored by monitor 612. A higher-level monitor 616 may be configured to monitor the monitor 624, which itself may monitor workload A 602 and workload B 606, as well as monitor 612, which itself is configured to monitor the workload C 610. Although this is merely one configuration, it is intended to indicate that monitors may be nested into various levels to monitor one or more workflows and/or one or more other monitors that themselves monitor one or more other workflows.

In addition or as an alternative to the hierarchical monitoring as described above, complex robotics systems may require a task-dependent monitoring approach. For instance, consider an autonomous mobile robot (AMR) equipped with a robotic arm, i.e., a mobile manipulator. If the frequency of the velocity command sent to the actuators does not consistently meet a desired level (e.g. a desired performance level, a desired accuracy level, a desired efficiency level, etc.) while the mobile base is navigating toward a desired goal position, this may indicate that system is in a failure state. In contrast, if there are no velocity commands sent to the mobile base while the robot is standing to manipulate objects with its arm and/or end-effector, the system may be considered healthy if the joint-states of the arm and the object list from the corresponding pose-estimation modules are delivering their data at a healthy frequency. At the same time, the availability of meaningful data from various sensor sources (such as Light Detection and Ranging (LiDAR), internal measurement unit (IMU), Cameras and Joint sensors) may require constant monitoring, such as in parallel to the task-dependent monitoring objectives, which are only active if certain conditions are fulfilled. To encode such a complex system of dependencies, the task-dependent monitoring may employ a behavior tree representation.

FIG. 7 depicts a visualization of the behavior tree representation of the mobile manipulator example. As an illustrative example of this behavior tree, the task-dependent monitor may first determine whether the robot is idle 702. If it is idle, then the task-dependent monitor may simply sure that sensor data is available 704 for further monitoring. If it is not idle 702, then it may determine whether the robot is navigating 706 or whether the robot is engaged in item picking 708 (or any other task that is performed while not navigating; item picking is selected here for demonstrative purposes only). If the robot is navigating 706, then task-dependent monitor may determine whether navigation control codes are available 710 and/or whether the robot's position in the map is changing 712. If the robot is engaged in item picking 708, then the task-dependent monitor may determine whether manipulator control commands are available 714 and/or whether object detection results are available. Otherwise stated, since navigation and item-picking usually occur separately (e.g. the robot does not usually navigate while item-picking, and the robot does not generally item-pick while navigating), the task-dependent monitor may focus on monitoring the relevant activities/modules/data sets, etc. for the particular task that the robot is performing. In this manner, the task-dependent monitor may employ an organized decision tree to ensure that proper determinations have been made for the robot's current activity.

Additionally or alternatively to hierarchical monitoring and/or task-aware monitoring is behavioral monitoring, which may be an approach that is unique to cyber-physical systems. As robotic systems interact with the physical (or simulated) world, the resulting behaviors (e.g., movement of the manipulator or the mobile base driving along path) can be monitored through external sensors such as cameras or LIDARs and further through object detection and tracking algorithms (for example, employing modern AI approaches). The comparison of detected and expected behaviors can give strong hints about the health of the robotic application.

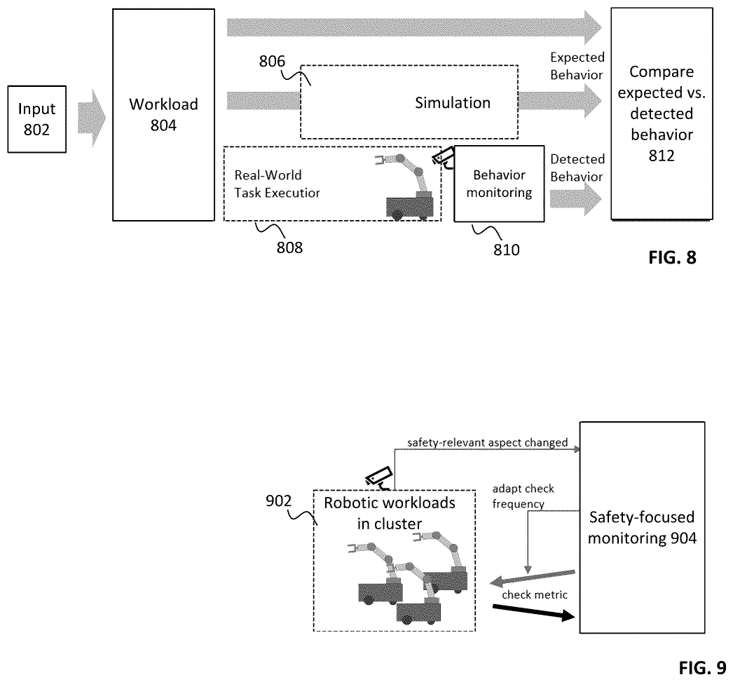

FIG. 8 depicts an example of behavioral monitoring. That is, and as other aspects of this disclosure, the workload may be executed in whole or in part in the edge or cloud server, and instructions may be sent to the robot for performance of the relevant task. The edge or cloud server may include a behavior monitor that may monitor the robot's behavior relative to a standard (e.g. an idealized standard) and adjust resources accordingly. In this figure, an input 802 (e.g., sensor input, task instructions, etc.) is sent to a workload 804, which is executed for ultimate performance of a task by the robot. The execution of the workload take two paths in parallel, which allows for a comparison. First, the robot's behavior is simulated (see simulation 806), wherein the simulation is based on the robot's behavior in which the workload is carried out given a particular (optionally an idealized) set of resources. This may be, for example, a simulation of workload performance using all available resources (e.g. all CPUs, all GPUs, models with greater numbers of parameters, etc.), or some other level of resources than what is actually available to the robot. Although such a level of simulated resources may be a level that is greater than that that is currently available to the robot, in some configurations, it may be desirable to simulate workload performance given fewer resources than those currently available. In parallel to the simulation 806, the real-world execution 808 of the robot is determined. In particular, the robot executes the workload results in the real-world execution 808, and the behavior or performance of the robot is monitored 810 (e.g., such as through cameras taking video of the robot, or another other monitoring means). That is, given the resources that are actually assigned to the execution of the workload 804 in the edge server or the cloud server, the actual performance of the robot is evaluated (e.g., how well is the robot navigating? How accurately is the robot item-picking? etc.). The results of simulation 806 and real-world execution 808 (or the monitoring 810 of the real-world execution 808) are compared 812, and decisions may be made as to increase or decrease the available resources for workload performance in the edge server or the cloud server based on a desire to made the real-world performance more closely monitor the simulated performance, or, conversely, if the real-world performance is already similar to or better than the simulated performance, and assuming some buffer in which performance can be worse and still remaining within a tolerance or level of acceptability, it may be possible or desirable to reduce a number of resources available the workload.

For instance, if the monitoring system detects through introspection that a mobile robot is slowing down while external sensors do not detect a meaningful reason (e.g., dynamic or static obstacles blocking the robot's path) for the behavioral change, a reasonable explanation may be that one or more software components are in an unhealthy state, which may require attention from the resource optimization system. In such a case, a simulated copy of the robot's environment could be used in parallel to evaluate the effect of one or more countermeasures on the robot's behavior in a safe and controlled setup before applying the change to the physical robot in operation.

Alternatively or in additional to any of the hierarchical monitoring, task-aware monitoring, or behavioral monitoring, safety-focused monitoring may be employed. Certain circumstances may require safety-focused monitoring that considers the reality that safety-related or safety-critical workloads may require different modes of monitoring, such that, depending on the criticality, certain checks might be triggered more often. FIG. 9 depicts a safety-focused monitoring system, according to an aspect of the disclosure. In this system, various workloads are performed 902, and the system monitors the performance of these workloads for safety-related aspects (e.g. using safety-focused monitoring 904 or a safety-focused monitor). The safety-related aspects may include anything as selected for a given implementation; however, two such aspects may include the presence of a human in a vicinity of a robot and/or the speed at which a robot is moving/navigating/locomoting. Based on the presence of one or more of these safety-related aspects, the safety-focused monitor 904 may implement one or more precautions to ensure user safety. For example, if a mobile robot is the only entity that is slowly moving within an area, the monitoring might check the obstacle avoidance workload with a frequency of 1 second. However, if the robot is moving at a higher speed, or a human comes into the scene, the monitoring frequency may be increased to ensure a detection (and proper reaction) is triggered in time (e.g. a frequency of greater than once per second).

The criticality in terms of safety of certain monitored metric can be externally defined, such as by a human expert, or automatically learned by an AI approach. For instance, such a criticality assessment could be estimated through a continuous reinforcement learning approach in a simulated environment, where the reward for different criticality parameters is the actual behavior of the robot as provided by the simulation. That is, if a change in criticality results in collisions or dangerous near-collisions in a mobile robot navigation use-case, this setup will be punished by receiving a low reward whereas navigating longer distances without dangerous situations will be rewarded. Such a reward for mobile robot could be formalized as follows:

$$r = \frac{{dist}_{travelled}}{{ω}_{nearCollisions} \cdot {num}_{nearCollisions} + {ω}_{collisions} \cdot {num}_{collisions}} \qquad ( 1 )$$

wherein r is the reward; dist is the distance (such as the distance travelled); omega is the weight of collisions and near collisions, and num is the number of collisions and near collisions. In this manner, the reward is increased by distance travelled safely and reduced by collisions and near collisions. The omega weight value can be adjusted to weight the significant of a near collision versus an actual collision as desired. In an optional configuration, the frequency at which such safety-relevant metrics are captured could be part of the learning system.

Another important aspect of this system may be the optimization of resource usage. The information collected by the hierarchical and the task-aware and behavior-aware monitoring systems can be used to manage and ideally optimize the resource usage within the compute cluster. Therefore, the monitoring system permanently keeps track of the task and the state of the system and compares its expected behavior with the actually detected behavior. We foresee multiple optimization approaches that are described in the following sections.

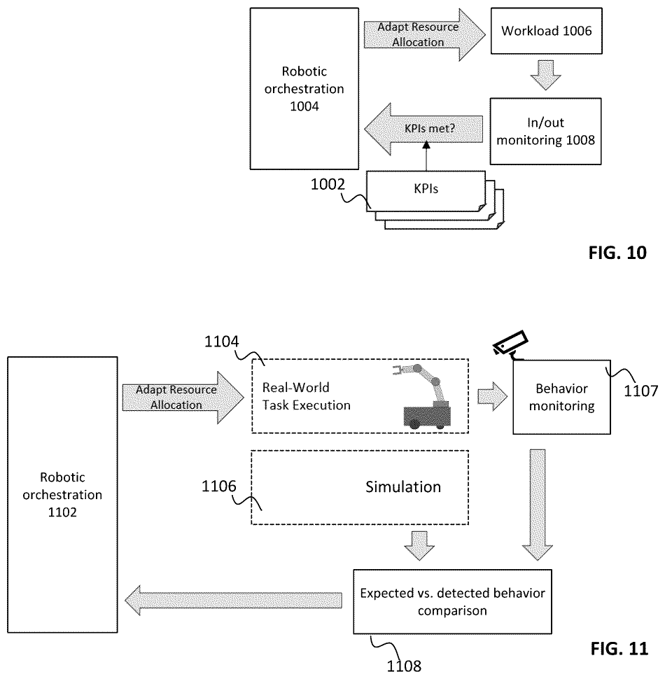

A first option for an optimization approach is referred to herein as key performance indicator (KPI) optimization. FIG. 10 depicts KPI optimization according to an aspect of the disclosure. In this figure, KPIs 1002 for workload performance are programmed and stored, such as on a memory. An orchestrator (e.g., a robotic workload resource orchestrator) 1004 selects resources for performance of one or more workloads 1006. A monitor 1008 monitors the performance of the various workloads and determines whether one or more of the KPIs 1002 are satisfied. If the relevant KPI or KPIs is/are satisfied, then the selected resources may be maintained or even reduced. If, however, one or more KPIs is not satisfied, then the orchestrator 1004 may select one or more additional resources for performance of the workloads 1006. For instance, if a certain workload is not able to consistently achieve its desired cycle or execution time, the orchestrator 1004 may increase the number of resources assigned to the workload at run-time to ensure the workload is able to meet its (user-defined) requirements. However, this requires the orchestrator 1004 to monitor available resources on the specific node of the compute cluster to ensure that the overall system remains in a healthy state.

A second optimization option is described herein as behavior-aware resource optimization. FIG. 11 depicts behavior-aware resource optimization according to an aspect of the disclosure. In this figure, the orchestrator 1102 selects resources for a workload and causes the workload to be executed with the selected resources. In parallel, a simulator 1106 performs a simulation of workload performance with a different set of resources. These may be, for example, a greater amount of resources, fewer resources, or merely different resources. This could be, for example, adding or subtracting CPUs for workload performance, adding or subtracting GPUs for workload performance, adding or subtracting memory for workload performance, changing to a model having more parameters than a current model for workload performance, or changing to a model having fewer parameters than a current model for workload performance. The actual performance of the robot (the real-world task execution 1104) is monitored 1107 and the monitored behavior is compared to the simulated behavior 1108. On the basis of this comparison, fewer or additional resources may be selected for workload performance. For example, if the motion of an autonomous mobile robot is bumpy or if the robot is deviating significantly from its planned path, which is known by the monitoring system, one possible reason could be a suboptimal resource allocation for certain software modules. The monitoring system can adjust and optimize the resource allocation at runtime to resolve the erratic behavior and bring the overall system to a functional healthy state again, that is, minimizing the difference between the expected and observed behavior over all resource allocation mappings o, that is:

$$\frac{min ( {b}_{expected} - {b}_{observed} )}{φ} \qquad ( 2 )$$

This optimization may occur in parallel, such as by duplicating the erratic behavior in a simulated copy of the environment and iteratively minimizing over different resource allocation mappings and applying the optimized result to the actual deployment currently in operation. Alternatively, it could be iteratively optimized over a subset of resource allocation mappings while the robot application is running. To reduce the sample space, setups with lower resource allocations may be omitted, as they will not improve the robotic systems' behavior as well as setups with extremely high resources, as there will be a break-even point, and it will therefore suffice to iteratively approach it this break-even point.

To map unexpected behaviors to specific workloads, several approaches are possible. First, in an a priori analysis approach, the resources for each robotic workload are iteratively reduced until it eventually stops (i.e., application failure). Furthermore, potential combinations of parallel workload resource changes are checked. The resulting behavior (for a specific, planned task) may then be compared to the expected behavior, and the differences (e.g., robot moves slower, robot deviates significantly from its planned path) are stored within a lookup table. Such evaluations may occur in a real-world test environment or in simulation. The list of expected-vs.-detected behavior-difference categories could either be expert-defined or generated and clustered by a learning approach such as k-means clustering. The input data for the learning approach could be the data of all communication channels and how they are connected to each other to define meaningful distance metrics. The second approach may include testing the impact on behaviors by applying minor changes to the resources and observing and evaluating the result during actual operation.

According to another aspect of the disclosure, the system may implement task-aware resource optimization. In such resource optimization, the system may consider, for example, the frequency and/or magnitude of task performance. In a robotics application, workloads are typically not permanently active and may not permanently operate at full capacity. For instance, consider an autonomous mobile robot equipped with a robotic arm, i.e., a mobile manipulator. Such a complex robotic system may operate multiple workloads in parallel, which may illustratively include localization, path-planning, path-following, obstacle/object detection, inverse kinematics, motion planning, etc. However, while the robotic arm manipulates objects, the mobile base typically remains static, and its algorithmic components remain idle. Similarly, while the mobile base is navigating the robot to its desired goal position, the robot arm and its algorithmic components are typically idle. Therefore, in a resource-constrained compute cluster, the proposed monitoring and resource management system can temporarily remove assigned compute resources from idle or inactive components and can potentially reassign them to currently active workloads that need additional resources during mission-critical operation. Additionally this task-dependent resource optimization may be applied to a fleet of robots where, depending on the fleet's current high-level task/mission, the overall task objective could be optimized to achieve either maximal execution speed or minimal resource usage across the compute cluster. This management and dynamic allocation of compute resources may be built on knowledge provided by the user about the “high-level” task of the robotic system and on the current feedback of the monitoring system reporting information about the workloads' state in terms of activation and resources.

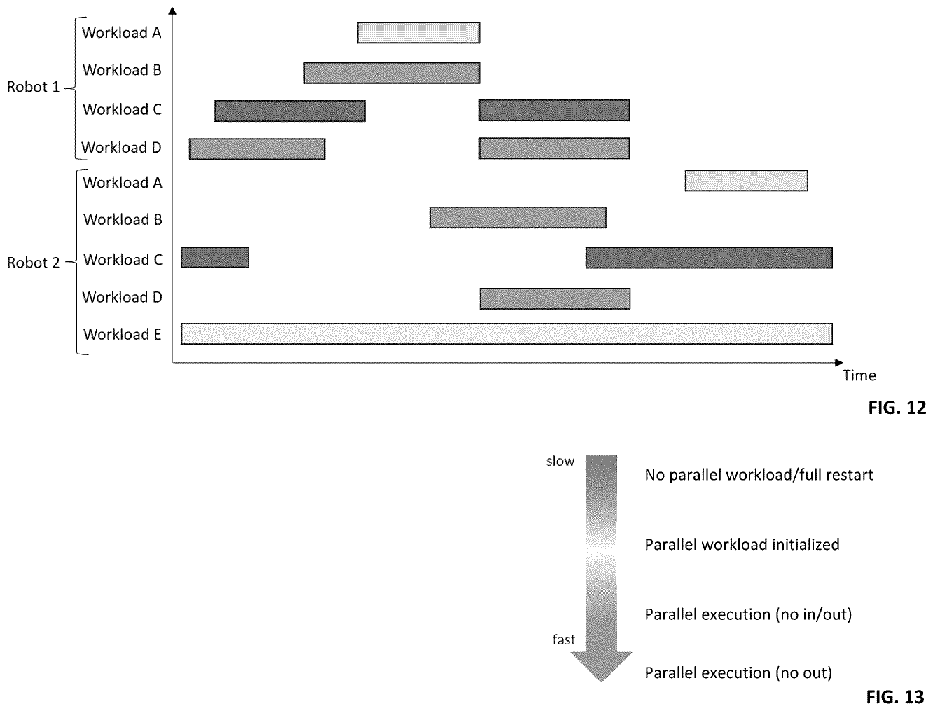

FIG. 12 depicts an example of task-dependent resource optimization, wherein different workloads are active at different points in time, especially for a fleet of robots. As can be seen, robot 1 may be configured to operate using workloads A, B, C, and D, yet these workloads may be needed at different times. Similarly, robot 2 may be configured to operate using workloads A, B, C, D, and E, which may also be needed at different times, such that fewer than each of these workloads temporally overlap.

To facilitate this approach, a workload activity schedule may be generated based on the planned high-level tasks and the robots involved in them. If the required workloads exceed the available resources during a certain timespan, the involved tasks are rescheduled to happen before or afterwards. As this might lead to increased task-execution times, a rescheduling might also happen on a higher level by reordering tasks.

According to another aspect of the disclosure, a safety-focused resource optimization may be utilized. In this manner, another resource optimization vector could be selecting between multiple available algorithmic components solving the same task at runtime. For instance, consider an algorithmic component employing a neural network of varying sizes, and thus requiring different resources depending on the networks size, such as YOLOv8 nano or large. During most of the time of the robotic task, a smaller, more resource-efficient variant of the workload is sufficient to ensure safe operation. However, if difficult situations with multiple robots operating close to each other arise or interaction with human co-workers becomes necessary, the optimization system may provide a more resource-demanding variant of the workload to increase its precision and accuracy and thus safety of the overall system.

One or more rules may define situations in which increased safety considerations are necessary and may show how they are taken into account. Therefore, data collected from all available sensors is used to check whether there is a safety-critical situation according to this ruleset. For instance, an edge-camera feeds its data into a state-of-the-art object detection and classification algorithm which detects if humans are at a safety-critical distance to any of the robots. Another option may be to analyze a task/mission and the robots and tools involved in it. Expert-defined requirements for each task/robot could also be incorporated (e.g., if a picking task needs higher precision to not harm a human).

According to another aspect of the disclosure, information collected by the hierarchical monitoring system may also be used to improve the robotic system's failure resilience and availability. One core aspect of cloud-native applications is to ensure that failing micro-services are timely monitored and restarted such that the end-user ideally does not experience notable down-times. However, in robotics applications with systems interacting with the physical world in real-time, additional measures need to be implemented. According to the monitoring system, failures can either be directly detected at a workload level or at a behavior level. Failures at workload level refer to a workload being in an unhealthy state, which are detected through introspection via missed KPIs such as desired data publication frequency, whereas failures at behavior level refer to the overall system being in an unhealthy state, which are detected using external sensors. In either case, the proposed error mitigation system ensures safety of the overall system. Depending on the level at which the failure was detected (i.e., workload or behavior level), the severity of the failure could vary and thus the strategy for recovering from the failure. Hence, the selection of the optimal error-mitigation strategy could be a system combining expert knowledge and an automatic recommendation system, that is employing a continuous learning approach such as reinforcement learning with the reward being based on the length of the system's downtime and/or the consumed computational resources, for example, according to the following formula:

$$r = {ω}_{1} \cdot \frac{1}{{t}_{down}} + {ω}_{2} \cdot \frac{1}{{\sum }_{C ϵ Cluster} {comp}_{c}} \qquad ( 3 )$$

According to another aspect of the disclosure, the system may include one or more failure recovery strategies. One relevant consideration is the time necessary to recover from an application failure and to bring the overall robotic system back to a functional state. This recovery time has two relevant aspects: 1) failure mitigation time at cluster level (microservice/pod restart and/or time for adjusting network connections) and 2) restart/configuration time at application level. FIG. 13 depicts a comparison of failure recovery approaches in order of their restart time. As can be seen, switching between workflows operating in parallel can be performed comparatively rapidly, whereas, on the other extreme, complete restarts of workflows may take significantly longer.

The easiest way to recover is to simply restart the failing component entirely. However, this is the slowest recovery strategy as it requires both failure mitigation at cluster and application level. On the other hand, this recovery strategy does not require additional computational resources besides the monitoring during operation.

If such slow recovery, or in other words, a longer down-time of the system is not acceptable (e.g. for safety critical workloads), another option may be to run a fallback workload in parallel to the main component to speed up the recovery time. The final recovery time may depend on the state the fallback workload is in, such as whether it is 1) initialized, 2) being executed without external communication, 3) or being executed while receiving external data but not sending data to the remainder of the system. All three strategies take the same time at cluster level namely switching the network policy and thereby “rewiring” the communication connections from the failing workload to its fallback counterpart. The difference comes in from the recovery at application level. If the fallback component is only initialized, it needs to be put into execution mode and possibly handed over the last healthy state of the failed main component, whereas if the fallback component is already in execution mode, this recovery component is not needed. Finally, if the fallback workload is already in execution mode and receiving external data, the recovery time at application level is not necessary entirely and the recovery time only consists of the network policy change. Once the failure is resolved, another instance may be used.

However, for some type of workloads, it could be impracticable to run a fully configured fallback workload in parallel with the main workload although a high availability is required by the system. For instance, consider a resource-hungry, AI-driven workload running one instance of each robot in the fleet, it might even be impossible to run one fallback workload for each main component just to ensure high availability in the (possibly rare) case of workload failure. In such a situation, it may be possible to run a simpler, less resource-hungry fallback workload taking over immediately from the failing and ensuring continued operation (despite reduced accuracy/performance) as an interim solution while the overall system may restart the full workload from scratch and reconnects it to the system once it is fully functional again.

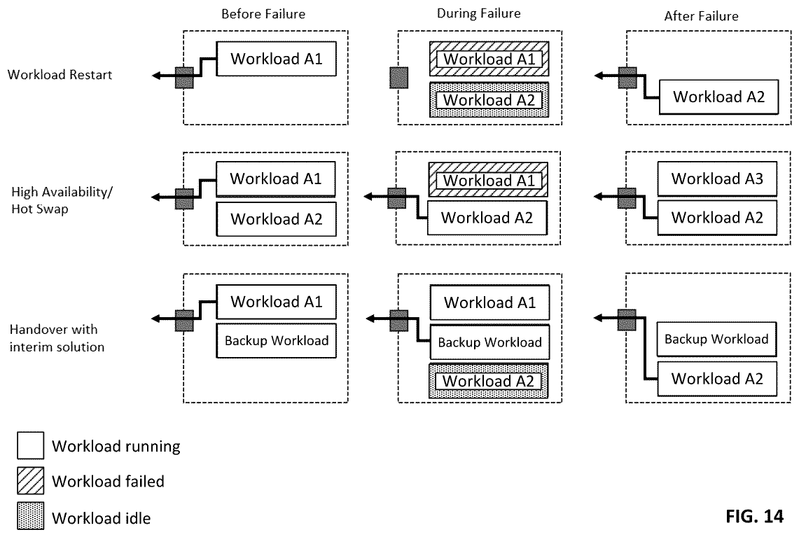

FIG. 14 depicts various handover approaches. In this figure, all workloads are operating appropriately in the column labeled “before failure”. In the next columns, labeled “during failure”, workload A1 has failed. This figure shows three options for recovery. According to the “workload restart” option, workload A2 was idle; workload A1 was stopped (e.g. paused, terminated, shut down, etc.), and workload A2 was started. In the high availability/hot-swap option, workload A1 failed, but workload A2 was operating in parallel and was functioning properly. As a result, the device switched to operating from workload A2. In this example, a new workload, Workload A3, was added to have an additional workload operating in parallel. Finally, with respect to the handover with interim solution option, workload A1 failed, while the backup workload was operating in parallel, and workload A2 was idle. Workload A1 was terminated, and the backup workload continued to operate while workload A2 was started.

That is, in addition to restarting the failing workload or connecting the running system to the fallback workload, it may be crucially important that the new instance (either fallback or restarted) properly picks up where the main workload failed, i.e., the last healthy state needs to be stored during operation and handed over from the failing workload. For instance, consider the localization component of a navigation system of an autonomous mobile robot (AMR). If the localization component fails during operation of a navigation mission, the robot's internal belief of its current position needs to be handed over the restarted or fallback localization workload. Hence, the user needs to define the states to be stored and handed over as parameters for the hierarchical monitoring system. Depending on the recovery strategy employed as described earlier, the steps performed during the recovery procedure potentially differ. Therefore, the proposed failure mitigation is able to run parametrizable, arbitrarily complex recovery procedures encoded as behavior tree, which it receives as a human-readable description in form of a configuration file defined by the user. Additionally, it is possible that the failing workload may critically depend on another (healthy) workload, which could even be necessary to restart/recover the healthy workload too. The proposed recovery approach based on behavior trees also supports such complex recovery scenarios by encapsulating such interdependencies within the behavior tree description.

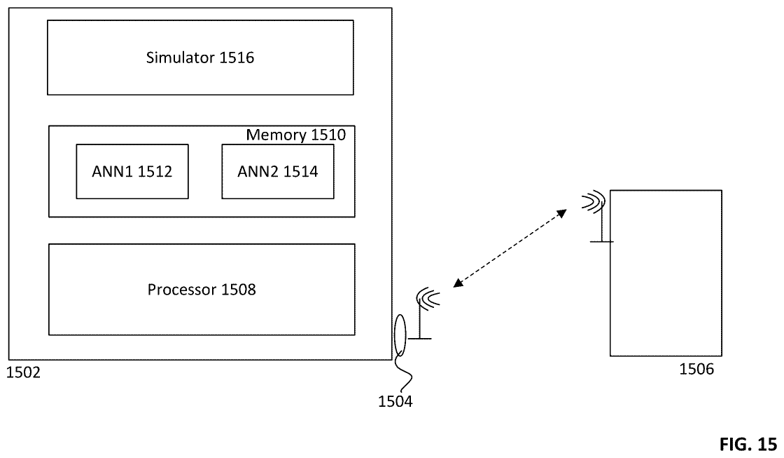

FIG. 15 depicts a server 1502, comprising an interface 1504, which may be configured to receive sensor data related to a robot 1506 or cyber-physical system (CPS). The interface may be an interface for wired or wireless communication. The interface may be connected to a modem and/or transceiver, which may be configured to receive a wireless signal, amplify the received wireless signal, demodulate the received signal, and otherwise decode the underlying data. It is expressly noted that although the sensor data are depicted as coming from the robot 1506 for demonstrative purposes, the sensor data may come from sensors that are located externally to the robot, or as part of the robot 1506, depending on the implementation. The server 1502 includes a processor 1508 (which may be or include multiple processors, such as multiple CPUs and/or multiple GPUs). The processor 1508 may be configured to determine a performance parameter of the CPS from the sensor data. The processor 1508 may further be configured to select a resource allocation strategy based on the performance parameter. The processor 1508 may further be configured to execute an algorithmic process on at least a portion of the sensor data according to the resource allocation strategy. The processor 1508 may further be configured to control a transmitter to send data representing an output of the executed artificial neural network to the robot.

In some configurations, the algorithmic process may include the execution of an artificial neural network. In this manner, the artificial neural network may be a first artificial neural network (ANN1) 1512, and the server may include the first artificial neural network 1512, such as by including a memory 1510 on which the first artificial neural network 1512 is stored. In some configurations, the artificial neural network may be a first artificial neural network 1512, and the server may further include a second artificial neural network 1514 (e.g., at least two artificial neural networks may be stored on the server, or stored on a memory to which the server has access). The processor 1508 may be further configured to select the resource allocation strategy comprising selecting either the first artificial neural network 1512 or the second artificial neural network 1514, based on the performance parameter, for execution on the at least a portion of the sensor data. That is, the resource allocation strategy may dictate the performance of one or more computational tasks using either the first artificial neural network 1512 or the second artificial neural network 1514. This may be relevant, for example, if the first artificial neural network 1512 and the second artificial neural network 1514 have different number of parameters, which in turn requires a different magnitude and/or kind of computational resources to execute, but which also might return differing degrees of accuracy. For example, when a robot 1506 is performing a safety critical task, performing a task in a vicinity of a human, or performing a task for which a high degree of accuracy is otherwise required, the processor 1508 may select an artificial neural network having a greater number of parameters, which may be thought to provide a more accurate output. This may, in turn, require that the processor 1508 select a greater number and/or a different kind of processing resources for processing via the selected artificial neural network.

In this manner, the processor 1508 may be further configured to select the resource allocation strategy comprising selecting a subset of the plurality of processing circuits based on the performance parameter and executing the algorithmic component (which may be or include the artificial neural network) using the subset of the plurality of processing circuits. In this manner, the processor 1508 may select any number and/or combination of graphics processing units (GPUs), central processing units (CPUs), or hardware memory circuits.

In some configurations, the processor 1508 may improve safety or success (or reduce task failure) by performing multiple instances of a workload, such that the CPS may switch (e.g. in real time) between the results of a first instance of the workload and a second instance of the workload. This switching may be desirable, for example, when the first instance between failure-prone, corrupted, or otherwise of poor health. The process of switching between instances of workloads in real-time may be known as a “hot-swap”. In this manner, the processor may be configured to implement a workload for the robot using the algorithmic process; and determine the resource allocation strategy comprising determining a number of parallel instances of the workload to run based on the performance parameter. In this configuration, the parallel instances may include a first parallel instance and a second parallel instance, and the processor may be further configured to determine whether a result of the first parallel instance satisfies one or more predetermined criteria (e.g., one or more key performance indicators, one or more failure rates, one or more latency requirements, one or more success rates, etc.). Based on satisfaction of the one or more predetermined conditions, the processor may select the first parallel instance (e.g., may cause a result of the first parallel instance to be sent to the robot) if the first parallel instance satisfies one or more predetermined conditions. Alternatively, the processor 1508 may cause a result of the second parallel instance to be sent to the robot if the first parallel instance fails to satisfy one or more predetermined conditions.

In one alternative configuration, the processor 1508 determining the performance parameter (e.g. determining whether the performance parameter is satisfied) may include the processor generating a simulated performance of the robot based on a first set of resources and comparing an actual performance of the robot to the simulated performance (e.g., such as generated by the simulator 1516). In this manner, the processor may compare the current, actual performance of the robot 1506 with a simulated performance of the robot. The simulated performance of the robot may be a simulation based on the robot's using of different resources than are currently being used by the robot. This may be or include a simulation of the robot using more or fewer CPUs than are currently used, faster or slower CPUs than are currently used, more or fewer GPUs than are currently used, faster or slower GPUs than are currently used, greater or less memory than is currently used, artificial neural networks with a greater or fewer number of parameters than those that are currently used, or any of these. In this manner, the processor may be further configured to select the resource allocation strategy based on a difference between the simulated performance and the actual performance. Although the simulator 1516 is depicted herein as a component of the server, the skilled person will appreciate that the simulator may be implemented in software.

According to another aspect of the disclosure, the processor 1508 may be configured to determine the performance parameter based on a task that the robot 1506 is performing or is scheduled to perform. In this manner, certain tasks may be associated with greater or less criticality, greater or less failure tolerance, greater or less need for accuracy, greater or less need for safety, or any of these. The processor 1508 may have access to (e.g., may know of) a task that the robot is performing or scheduled to perform, and the processor may select resources for the performance of this task (e.g. CPUs, GPUs, memories, specific models, etc.) based on the above task-related factors.

According to another aspect of the disclosure, the processor 1508 may be configured to select the performance parameter based on proximity to humans (e.g. the proximity of the robot to a human). That is, the presence of a human in a vicinity of a robot may invoke a greater need for safety, and therefore it may be or become necessary to select resources for performance of the task in such a manner as to yield results with greater safety. In this manner, the processor 1508 may be configured to detect the presence of a human from the sensor data using any known method of human detection. Such methods may include, but are not limited to, object detection from image sensor data, pose estimation from image sensor data, facial recognition from image sensor data, infrared detection from one or more infrared sensors or thermal cameras, object detection from ultrasonic sensor data, object detection from radar data, object detection from LiDAR data, sound pattern recognition from acoustic sensor data, object recognition from pressure sensor data, human recognition from biometric sensor data, or human detection from carbon dioxide (CO2) or breath detection sensor data.

Additionally or alternatively to the server's detection of the presence of a human through sensor data, the server may be configured to receive from a robot a report that a human is within a vicinity of the robot. In this manner, any of the sensor-based detection methods described above with result to the server may be carried out locally in the robot. Alternatively, the robot may use any known method for human detection and may simply report the presence of a detected human to the server. The robot may optionally also report a number of detected humans, an estimated distance of a detected human from the robot, an activity of a detected human, an estimated danger of a robot to the detected human, or the like. Based on this received information, the processor may be configured to determine the performance parameter based on the report.

The processor 1508 may be optionally configured to determine the performance parameter based on a number or frequency of robot errors that occurred within a predetermined duration.

The number or frequency of robot errors can refer to any negative event. Specific negative events for such robots errors may be or include a number or frequency of collisions of the robot with one or more objects, a number or frequency of times the robot drops or damages one or more objects, a number or frequency of times the robot comes within a predetermined distance of a human, or any of these.

The processor 1508 may be configured to determine the performance parameter based on a number of detected task failures of the robot. This may include, for example, the processor being configured to determine the performance parameter based on a severity of one or more detected failures of the robot. Such failures may include, but are not limited to, collisions with another object or person, injury to person, or property damage. Other potential task failures include less severe issues, such as deviation from a plan, deviation from a planned route, reaction time beneath an acceptable threshold (e.g. reaction time following a control request), missing sensor data, incomplete sensor data, failure to report, inadequate or incomplete reports, etc.

The algorithmic process as described herein may be or include the CPS performing a robot localization function (e.g. determining a location or position of the robot within a physical space, relative to a fixed object, or an absolute location based on a coordinate system). The algorithmic process may be or include the CPS performing a robot path planning function (e.g., determining a direction or path of travel from a first location to a destination location). The algorithmic process may be or include the CPS performing an object manipulation function (e.g., grasping an object, moving an object, altering the form of an object, applying external energy to the object, etc.)

Throughout this disclosure, sensor data has been disclosed as the basis upon which various determinations may be made. The sensor data may be data from one or more sensors on or within a robot, one or more sensors in a vicinity of the robot (e.g., external to the robot which may detect information about the robot, such as an image of the robot, a speed of the robot, a location of the robot, a distance of the robot from another object, etc), or any combination thereof.

Although much of this disclosure describes a server and a robot as part of a CPS, the CPS may include a plurality of robots. This may be referred to as a robot management system. The robot management system may include a first robot, which may be or perform any of the activities of any robot disclosed herein, and a second robot, which may also be or perform any of the activities of any robot disclosed herein. In this manner, the processor may be configured to determine a performance parameter of the first robot from the sensor data; select a resource allocation strategy for the first robot based on the performance parameter; execute the algorithmic process for a first robot workflow on at least a portion of the sensor data according to the resource allocation strategy; control a transmitter to send data representing a result of the execution of the algorithmic process to the first robot; and determine a performance parameter of the second robot from the sensor data; select a resource allocation strategy for the second robot based on the performance parameter; execute the algorithmic process for a second robot workflow on at least a portion of the sensor data according to the resource allocation strategy; and control a transmitter to send data representing a result of the execution of the algorithmic process to the second robot. In this manner, the processes and methods disclosed herein may be applied to the management of one or more robots (e.g., a fleet of robots).

The sensor data as disclosed herein may be sensor data from any or any combination of sources. In one configuration, the robot (e.g., the first robot) may include one or more sensors, which it may use to detect information about its performance and/or its surroundings. In another configuration, the first robot may include one or more sensors, which it may use to detect information about the performance of a second robot. In a third configuration, the environment of the first or the second robot may include one or more sensors (e.g., wall-mounted sensors, floor-mounted sensors, ceiling-mounted sensors, etc.), which may be used to detect information about the first robot, the second robot, the environment, or any of these.

Further aspects of the disclosure will be described by way of Example:

In Example 1, a server, comprising an interface, configured to receive sensor data related to a cyber-physical system (CPS) comprising a robot; and a processor, configured to: determine a performance parameter of the CPS from the sensor data; select a resource allocation strategy based on the performance parameter; execute an algorithmic process (which may be a coded series of steps or the execution of an artificial neural network) on at least a portion of the sensor data according to the resource allocation strategy; and control a transmitter to send data representing an output of the executed artificial neural network to the robot.

In Example 2, the server of claim 1, wherein the algorithmic process comprises execution of an artificial neural network; further comprising: the artificial neural network, wherein the artificial neural network is a first artificial neural network; and a second artificial neural network; wherein the processor is further configured to select the resource allocation strategy comprising selecting either the first artificial neural network or the second artificial neural network, based on the performance parameter, for execution on the at least a portion of the sensor data.

In Example 3, the server of claim 1 or 2, further comprising a plurality of processing circuits; wherein the processor is further configured to select the resource allocation strategy comprising selecting a subset of the plurality of processing circuits based on the performance parameter and executing the artificial neural network using the subset of the plurality of processing circuits.

In Example 4, the server of claim 3, wherein the plurality of processing circuits comprise a plurality of graphics processing units.

In Example 5, the server of claim 3 or 4, wherein the plurality of processing circuits comprise a plurality of central processing units.

In Example 6, the server of any one of claims 3 to 5, wherein the plurality of processing circuits comprise a plurality of hardware memory circuits.

In Example 7, the server of any one of claims 1 to 6, wherein the processor is further configured to: implement a workload for the CPS using the algorithmic process; and determine the resource allocation strategy comprising determining a number of parallel instances of the workload to run based on the performance parameter.

In Example 8, the server of claim 7, wherein the parallel instances comprise a first parallel instance and a second parallel instance; wherein the processor is further configured to: determine whether a result of the first parallel instance satisfies one or more predetermined criteria; cause data representing a result of the first parallel instance to be sent to the robot if the first parallel instance satisfies one or more predetermined conditions; and cause data representing a result of the second parallel instance to be sent to the robot if the first parallel instance fails to satisfy one or more predetermined conditions.

In Example 9, the server of any one of claims 1 to 8, wherein the processor is further configured to determine the performance parameter by determining that a performance of the CPS satisfies one or more key performance indicators.

In Example 10, the server of any one of claims 1 to 9, wherein the processor is further configured to determine the performance parameter by generating a simulated performance of the CPS based on a first set of resources and comparing an actual performance of the CPS to the simulated performance.

In Example 11, the server of claim 10, wherein the processor is further configured to select the resource allocation strategy based on a difference between the simulated performance and the actual performance.

In Example 12, the server of any one of claims 1 to 11, wherein the processor is configured to determine the performance parameter based on a task that the CPS is performing or is scheduled to perform.

In Example 13, the server of any one of claims 1 to 12, wherein the processor is configured to determine the performance parameter based on whether the sensor data indicate that the CPS is operating within a vicinity of a human.

In Example 14, the server of claim 13, wherein the processor is configured to detect the presence of a human from the sensor data by using any of object detection from image sensor data, pose estimation from image sensor data, facial recognition from image sensor data, infrared detection from one or more infrared sensors or thermal cameras, object detection from ultrasonic sensor data, object detection from radar data, object detection from LiDAR data, sound pattern recognition from acoustic sensor data, object recognition from pressure sensor data, human recognition from biometric sensor data, or human detection from CO2 or breath detection sensor data.

In Example 15, the server of any one of claims 1 to 13, wherein the processor is configured to receive a report from the robot regarding whether the robot is operating within a vicinity of a human, and wherein the processor is configured to determine the performance parameter based on the report.

In Example 16, the server of any one of claims 1 to 15, wherein the processor is configured to determine the performance parameter based on a number or frequency of robot errors that occurred within a predetermined duration.

In Example 17, the server of claim 16, wherein the number or frequency of robot errors is a number or frequency of collisions of the robot with one or more objects.

In Example 18, the server of claim 16, wherein the number or frequency of robot errors is a number or frequency of times the robot drops or damages one or more objects.

In Example 19, the server of claim 17, wherein the number or frequency of robot errors is the number or frequency of times the robot comes within a predetermined distance of a human.

In Example 20, the server of any one of claims 1 to 19, wherein the processor is configured to determine the performance parameter based on a number of detected task failures of the robot.

In Example 21, the server of any one of claims 1 to 20, wherein the processor is configured to determine the performance parameter based on a severity of one or more detected failures of the robot.

In Example 22, the server of any one of claims 1 to 20, wherein the algorithmic process is configured to perform a robot localization function.

In Example 23, the server of any one of claims 1 to 21, wherein the algorithmic process is configured to perform a robot path planning function.

In Example 24, the server of any one of claims 1 to 22, wherein the algorithmic process is configured to perform an object manipulation function.

In Example 25, the server of any one of claims 1 to 23, wherein the sensor data comprises LIDAR data from the robot.

In Example 26, the server of any one of claims 1 to 24, wherein the sensor data comprises RADAR data from the robot.

In Example 27, the server of any one of claims 1 to 25, wherein the sensor data comprises camera data from the robot.

In Example 28, the server of any one of claims 1 to 26, wherein the sensor data comprises LIDAR data representing an image of the robot.

In Example 29, the server of any one of claims 1 to 27, wherein the sensor data comprises

RADAR data representing an image of the robot.

In Example 30, the server of any one of claims 1 to 28, wherein the sensor data comprises camera data representing an image of the robot.

In Example 31, a robot management system, comprising: the server of any one of claims 1 to 30; a first robot; and a second robot; wherein the processor is configured to: determine a performance parameter of the first robot from the sensor data; select a resource allocation strategy for the first robot based on the performance parameter; execute the algorithmic process for a first robot workflow on at least a portion of the sensor data according to the resource allocation strategy; and control a transmitter to send data representing a result of the execution of the algorithmic process to the first robot; and determine a performance parameter of the second robot from the sensor data; select a resource allocation strategy for the second robot based on the performance parameter; execute the algorithmic process for a second robot workflow on at least a portion of the sensor data according to the resource allocation strategy; and control a transmitter to send data representing a result of the execution of the algorithmic process to the second robot.

In Example 32, a non-transitory computer readable medium, comprising instructions which, if executed by a processor, cause the processor to: receive sensor data related to a cyber-physical system (CPS) comprising a robot; determine a performance parameter of the CPS from the sensor data; select a resource allocation strategy based on the performance parameter; execute an algorithmic process on at least a portion of the sensor data according to the resource allocation strategy; and control a transmitter to send data representing an output of the executed artificial neural network to the robot.

In Example 33, the non-transitory computer readable medium of claim 32, wherein the algorithmic process comprises execution of an artificial neural network; further comprising: the artificial neural network, wherein the artificial neural network is a first artificial neural network; and a second artificial neural network; wherein the instructions are further configured to cause the processor to select the resource allocation strategy comprising selecting either the first artificial neural network or the second artificial neural network, based on the performance parameter, for execution on the at least a portion of the sensor data.

In Example 34, the non-transitory computer readable medium of claim 32 or 33, wherein the instructions are further configured to cause the processor to select the resource allocation strategy by selecting a subset of a plurality of processing circuits based on the performance parameter and executing the artificial neural network using the subset of the plurality of processing circuits.

In Example 35, the non-transitory computer readable medium of claim 34, wherein the plurality of processing circuits comprise a plurality of graphics processing units.

In Example 36, the non-transitory computer readable medium of claim 34 or 35, wherein the plurality of processing circuits comprise a plurality of central processing units.

In Example 37, the non-transitory computer readable medium of any one of claims 34 to 36, wherein the plurality of processing circuits comprise a plurality of hardware memory circuits.

In Example 38, the non-transitory computer readable medium of any one of claims 32 to 37, wherein the instructions are further configured to cause the processor to: implement a workload for the CPS using the algorithmic process; and determine the resource allocation strategy comprising determining a number of parallel instances of the workload to run based on the performance parameter.

In Example 39, the non-transitory computer readable medium of claim 38, wherein the parallel instances comprise a first parallel instance and a second parallel instance; wherein the instructions are further configured to cause the processor to: determine whether a result of the first parallel instance satisfies one or more predetermined criteria; cause data representing a result of the first parallel instance to be sent to the robot if the first parallel instance satisfies one or more predetermined conditions; and cause data representing a result of the second parallel instance to be sent to the robot if the first parallel instance fails to satisfy one or more predetermined conditions.

In Example 40, the non-transitory computer readable medium of any one of claims 32 to 39, wherein the instructions are further configured to cause the processor to determine the performance parameter comprising determining that a performance of the CPS satisfies one or more key performance indicators.

In Example 41, the non-transitory computer readable medium of any one of claims 32 to 40, wherein the instructions are further configured to cause the processor to determine the performance parameter by generating a simulated performance of the CPS based on a first set of resources and comparing an actual performance of the CPS to the simulated performance.

In Example 42, the non-transitory computer readable medium of claim 41, wherein the instructions are further configured to cause the processor to select the resource allocation strategy based on a difference between the simulated performance and the actual performance.

In Example 43, the non-transitory computer readable medium of any one of claims 32 to 42, wherein the instructions are further configured to cause the processor to determine the performance parameter based on a task that the CPS is performing or is scheduled to perform.

In Example 44, the non-transitory computer readable medium of any one of claims 32 to 43, wherein the instructions are further configured to cause the processor to determine the performance parameter based on whether the sensor data indicate that the CPS is operating within a vicinity of a human.

In Example 45, the non-transitory computer readable medium of claim 44, wherein the instructions are further configured to cause the processor to detect the presence of a human from the sensor data by using any of object detection from image sensor data, pose estimation from image sensor data, facial recognition from image sensor data, infrared detection from one or more infrared sensors or thermal cameras, object detection from ultrasonic sensor data, object detection from radar data, object detection from LiDAR data, sound pattern recognition from acoustic sensor data, object recognition from pressure sensor data, human recognition from biometric sensor data, or human detection from CO2 or breath detection sensor data.

In Example 46, the non-transitory computer readable medium of any one of claims 32 to 44, wherein the instructions are further configured to cause the processor to receive a report from the robot regarding whether the robot is operating within a vicinity of a human, and determine the performance parameter based on the report.

In Example 47, the non-transitory computer readable medium of any one of claims 32 to 46, wherein the instructions are further configured to cause the processor to determine the performance parameter based on a number or frequency of robot errors that occurred within a predetermined duration.

In Example 48, the non-transitory computer readable medium of claim 47, wherein the number or frequency of robot errors is a number or frequency of collisions of the robot with one or more objects.

In Example 49, the non-transitory computer readable medium of claim 47, wherein the number or frequency of robot errors is a number or frequency of times the robot drops or damages one or more objects.

In Example 50, the non-transitory computer readable medium of claim 48, wherein the number or frequency of robot errors is the number or frequency of times the robot comes within a predetermined distance of a human.

In Example 51, the non-transitory computer readable medium of any one of claims 32 to

50, wherein the instructions are further configured to cause the processor to determine the performance parameter based on a number of detected task failures of the robot.

In Example 52, the non-transitory computer readable medium of any one of claims 32 to 51, wherein the instructions are further configured to cause the processor to determine the performance parameter based on a severity of one or more detected failures of the robot.

In Example 53, the non-transitory computer readable medium of any one of claims 32 to 51, wherein the algorithmic process is configured to perform a robot localization function.

In Example 54, the non-transitory computer readable medium of any one of claims 32 to 52, wherein the algorithmic process is configured to perform a robot path planning function.

In Example 55, the non-transitory computer readable medium of any one of claims 32 to 53, wherein the algorithmic process is configured to perform an object manipulation function.

In Example 56, the non-transitory computer readable medium of any one of claims 32 to 54, wherein the sensor data comprises LIDAR data from the robot.

In Example 57, the non-transitory computer readable medium of any one of claims 32 to 55, wherein the sensor data comprises RADAR data from the robot.

In Example 58, the non-transitory computer readable medium of any one of claims 32 to 56, wherein the sensor data comprises camera data from the robot.

In Example 59, the non-transitory computer readable medium of any one of claims 32 to 57, wherein the sensor data comprises LIDAR data representing an image of the robot.

In Example 60, the non-transitory computer readable medium of any one of claims 32 to 58, wherein the sensor data comprises RADAR data representing an image of the robot.

In Example 61, the non-transitory computer readable medium of any one of claims 32 to 59, wherein the sensor data comprises camera data representing an image of the robot.

In Example 62, the robot management system, comprising: The non-transitory computer readable medium of any one of claims 32 to 61; a first robot; and a second robot; wherein the instructions are further configured to cause the processor to: determine a performance parameter of the first robot from the sensor data; select a resource allocation strategy for the first robot based on the performance parameter; execute the algorithmic process for a first robot workflow on at least a portion of the sensor data according to the resource allocation strategy; and control a transmitter to send data representing a result of the execution of the algorithmic process to the first robot; and determine a performance parameter of the second robot from the sensor data; select a resource allocation strategy for the second robot based on the performance parameter; execute the algorithmic process for a second robot workflow on at least a portion of the sensor data according to the resource allocation strategy; and control a transmitter to send data representing a result of the execution of the algorithmic process to the second robot.

In Example 63, the resource manager for managing resources in a cyber-physical system, comprising: an interface, configured to receive sensor data related to a cyber-physical system (CPS) comprising a robot; and a processing means, configured to: determine a performance parameter of the CPS from the sensor data; select a resource allocation strategy based on the performance parameter; execute an algorithmic process on at least a portion of the sensor data according to the resource allocation strategy; and control a transmitter to send data representing an output of the executed artificial neural network to the robot.

In Example 64, the resource manager of claim 63, wherein the algorithmic process comprises execution of an artificial neural network; further comprising: the artificial neural network, wherein the artificial neural network is a first artificial neural network; and a second artificial neural network; wherein the processing means is further configured to select the resource allocation strategy comprising selecting either the first artificial neural network or the second artificial neural network, based on the performance parameter, for execution on the at least a portion of the sensor data.

In Example 65, the resource manager of claim 63 or 64, further comprising a plurality of processing circuits; wherein the processing means is further configured to select the resource allocation strategy comprising selecting a subset of the plurality of processing circuits based on the performance parameter and executing the artificial neural network using the subset of the plurality of processing circuits.

In Example 66, the resource manager of claim 65, wherein the plurality of processing circuits comprise a plurality of graphics processing units.

In Example 67, the resource manager of claim 65 or 66, wherein the plurality of processing circuits comprise a plurality of central processing units.

In Example 68, the resource manager of any one of claims 65 to 67, wherein the plurality of processing circuits comprise a plurality of hardware memory circuits.

In Example 69, the resource manager of any one of claims 63 to 68, wherein the processing means is further configured to: implement a workload for the CPS using the algorithmic process; and determine the resource allocation strategy comprising determining a number of parallel instances of the workload to run based on the performance parameter.

In Example 70, the resource manager of claim 69, wherein the parallel instances comprise a first parallel instance and a second parallel instance; wherein the processing means is further configured to: determine whether a result of the first parallel instance satisfies one or more predetermined criteria; cause data representing a result of the first parallel instance to be sent to the robot if the first parallel instance satisfies one or more predetermined conditions; and cause data representing a result of the second parallel instance to be sent to the robot if the first parallel instance fails to satisfy one or more predetermined conditions.

In Example 71, the resource manager of any one of claims 63 to 70, wherein the processing means is further configured to determine the performance parameter by determining that a performance of the CPS satisfies one or more key performance indicators.

In Example 72, the resource manager of any one of claims 63 to 71, wherein the processing means is further configured to determine the performance parameter by generating a simulated performance of the CPS based on a first set of resources and comparing an actual performance of the CPS to the simulated performance.

In Example 73, the resource manager of claim 72, wherein the processing means is further configured to select the resource allocation strategy based on a difference between the simulated performance and the actual performance.

In Example 74, the resource manager of any one of claims 63 to 73, wherein the processing means is configured to determine the performance parameter based on a task that the CPS is performing or is scheduled to perform.

In Example 75, the resource manager of any one of claims 63 to 74, wherein the processing means is configured to determine the performance parameter based on whether the sensor data indicate that the CPS is operating within a vicinity of a human.

In Example 76, the resource manager of claim 75, wherein the processing means is configured to detect the presence of a human from the sensor data by using any of object detection from image sensor data, pose estimation from image sensor data, facial recognition from image sensor data, infrared detection from one or more infrared sensors or thermal cameras, object detection from ultrasonic sensor data, object detection from radar data, object detection from LiDAR data, sound pattern recognition from acoustic sensor data, object recognition from pressure sensor data, human recognition from biometric sensor data, or human detection from CO2 or breath detection sensor data.

In Example 77, the resource manager of any one of claims 63 to 75, wherein the processing means is configured to receive a report from the robot regarding whether the robot is operating within a vicinity of a human, and wherein the processing means is configured to determine the performance parameter based on the report.

In Example 78, the resource manager of any one of claims 63 to 77, wherein the processing means is configured to determine the performance parameter based on a number or frequency of robot errors that occurred within a predetermined duration.

In Example 79, the resource manager of claim 78, wherein the number or frequency of robot errors is a number or frequency of collisions of the robot with one or more objects.

In Example 80, the resource manager of claim 78, wherein the number or frequency of robot errors is a number or frequency of times the robot drops or damages one or more objects.

In Example 81, the resource manager of claim 79, wherein the number or frequency of robot errors is the number or frequency of times the robot comes within a predetermined distance of a human.

In Example 82, the resource manager of any one of claims 63 to 81, wherein the processing means is configured to determine the performance parameter based on a number of detected task failures of the robot.

In Example 83, the resource manager of any one of claims 63 to 82, wherein the processing means is configured to determine the performance parameter based on a severity of one or more detected failures of the robot.

In Example 84, the resource manager of any one of claims 63 to 82, wherein the algorithmic process is configured to perform a robot localization function.

In Example 85, the resource manager of any one of claims 63 to 83, wherein the algorithmic process is configured to perform a robot path planning function.

In Example 86, the resource manager of any one of claims 63 to 84, wherein the algorithmic process is configured to perform an object manipulation function.

In Example 87, the resource manager of any one of claims 63 to 85, wherein the sensor data comprises LIDAR data from the robot.

In Example 88, the resource manager of any one of claims 63 to 86, wherein the sensor data comprises RADAR data from the robot.

In Example 89, the resource manager of any one of claims 63 to 87, wherein the sensor data comprises camera data from the robot.

In Example 90, the resource manager of any one of claims 63 to 88, wherein the sensor data comprises LIDAR data representing an image of the robot.

In Example 91, the resource manager of any one of claims 63 to 89, wherein the sensor data comprises RADAR data representing an image of the robot.

In Example 92, the resource manager of any one of claims 63 to 90, wherein the sensor data comprises camera data representing an image of the robot.

In Example 93, the robot management system, comprising: the resource manager of any one of claims 63 to 92; a first robot; and a second robot; wherein the processing means is configured to: determine a performance parameter of the first robot from the sensor data; select a resource allocation strategy for the first robot based on the performance parameter; execute the algorithmic process for a first robot workflow on at least a portion of the sensor data according to the resource allocation strategy; and control a transmitter to send data representing a result of the execution of the algorithmic process to the first robot; and determine a performance parameter of the second robot from the sensor data; select a resource allocation strategy for the second robot based on the performance parameter; execute the algorithmic process for a second robot workflow on at least a portion of the sensor data according to the resource allocation strategy; and control a transmitter to send data representing a result of the execution of the algorithmic process to the second robot.

In Example 94, a robot includes a memory; a processor; and a sensor; wherein the processor is configured to: generate a performance parameter based on sensor data from the sensor, control a transceiver to send a first signal representing the performance parameter to a server; and receive a second signal representing instructions from the server.

In Example 95, the robot of Example 94 wherein the processor is further configured to control an actuator to perform a task in accordance with the instructions.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A server, comprising:
an interface, configured to receive sensor data related to a cyber-physical system (CPS) comprising a robot; and
a processor, configured to:
determine a performance parameter of the CPS from the sensor data;
select a resource allocation strategy based on the performance parameter;
execute an algorithmic process on at least a portion of the sensor data according to the resource allocation strategy; and
control a transmitter to send data representing an output of the executed algorithmic process to the robot.

2. The server of claim 1, wherein the algorithmic process comprises execution of an artificial neural network; further comprising:
the artificial neural network, wherein the artificial neural network is a first artificial neural network; and
a second artificial neural network; and
wherein the processor is further configured to select the resource allocation strategy comprising selecting either the first artificial neural network or the second artificial neural network, based on the performance parameter, for execution on the at least a portion of the sensor data.

3. The server of claim 1,
further comprising a plurality of processing circuits; and
wherein the processor is further configured to select the resource allocation strategy comprising selecting a subset of the plurality of processing circuits based on the performance parameter and executing the artificial neural network using the subset of the plurality of processing circuits.

4. The server of claim 3,
wherein the plurality of processing circuits comprise a plurality of graphics processing units, or wherein the plurality of processing circuits comprise a plurality of central processing units, or wherein the plurality of processing circuits comprise a plurality of hardware memory circuits.

5. The server of claim 1,
wherein the processor is further configured to:
implement a workload for the CPS using the algorithmic process; and
determine the resource allocation strategy comprising determining a number of parallel instances of the workload to run based on the performance parameter.

6. The server of claim 5,
wherein the parallel instances comprise a first parallel instance and a second parallel instance;
wherein the processor is further configured to:
determine whether a result of the first parallel instance satisfies one or more predetermined criteria;
cause data representing a result of the first parallel instance to be sent to the robot if the first parallel instance satisfies one or more predetermined conditions; and
cause data representing a result of the second parallel instance to be sent to the robot if the first parallel instance fails to satisfy one or more predetermined conditions.

7. The server of claim 1,
wherein the processor is further configured to determine the performance parameter by determining that a performance of the CPS satisfies one or more key performance indicators, or wherein the processor is further configured to determine the performance parameter by generating a simulated performance of the CPS based on a first set of resources and comparing an actual performance of the CPS to the simulated performance.

8. The server of claim 7,
wherein the processor is further configured to select the resource allocation strategy based on a difference between the simulated performance and the actual performance.

9. The server of claim 1,
wherein the processor is configured to determine the performance parameter based on a task that the CPS is performing or is scheduled to perform.

10. The server of claim 1,
wherein the processor is configured to determine the performance parameter based on whether the sensor data indicate that the CPS is operating within a vicinity of a human.

11. The server of claim 1,
wherein the processor is configured to receive a report from the robot regarding whether the robot is operating within a vicinity of a human, and
wherein the processor is configured to determine the performance parameter based on the report.

12. The server of claim 1,
wherein the processor is configured to determine the performance parameter based on a number or frequency of robot errors that occurred within a predetermined duration;
wherein the number or frequency of robot errors is a number or frequency of collisions of the robot with one or more objects, or wherein the number or frequency of robot errors is a number or frequency of times the robot drops or damages one or more objects, or wherein the number or frequency of robot errors is the number or frequency of times the robot comes within a predetermined distance of a human.

13. The server of claim 1,
wherein the processor is configured to determine the performance parameter based on a number of detected task failures of the robot, or based on a severity of one or more detected failures of the robot.

14. The server of claim 1,
wherein the algorithmic process is configured to perform a robot localization function, a robot path planning function, an object manipulation function, a collision avoidance function, or an obstacle detection and tracking function.

15. The server of claim 1,
wherein the sensor data comprises LIDAR data from the robot, RADAR data from the robot, wherein the sensor data comprises camera data from the robot, LIDAR data representing an image of the robot, RADAR data representing an image of the robot, or camera data representing an image of the robot.

16. A robot management system, comprising:
the server of claim 1;
a first robot; and
a second robot;
wherein the processor is configured to:
determine a performance parameter of the first robot from the sensor data;
select a resource allocation strategy for the first robot based on the performance parameter;
execute the algorithmic process for a first robot workflow on at least a portion of the sensor data according to the resource allocation strategy; and
control a transmitter to send data representing a result of the execution of the algorithmic process to the first robot; and
determine a performance parameter of the second robot from the sensor data;
select a resource allocation strategy for the second robot based on the performance parameter;
execute the algorithmic process for a second robot workflow on at least a portion of the sensor data according to the resource allocation strategy; and
control a transmitter to send data representing a result of the execution of the algorithmic process to the second robot.

17. A non-transitory computer readable medium, comprising instructions which, if executed by a processor, cause the processor to:
receive sensor data related to a cyber-physical system (CPS) comprising a robot;
determine a performance parameter of the CPS from the sensor data;
select a resource allocation strategy based on the performance parameter;
execute an algorithmic process on at least a portion of the sensor data according to the resource allocation strategy; and
control a transmitter to send data representing an output of the executed algorithmic process to the robot.

18. The non-transitory computer readable medium of claim 17, wherein the algorithmic process comprises execution of an artificial neural network; further comprising:
the artificial neural network, wherein the artificial neural network is a first artificial neural network; and
a second artificial neural network; and
wherein the instructions are further configured to cause the processor to select the resource allocation strategy comprising selecting either the first artificial neural network or the second artificial neural network, based on the performance parameter, for execution on the at least a portion of the sensor data.

19. A robot, comprising:
a memory;
a processor;
a sensor;
wherein the processor is configured to:
generate a performance parameter based on sensor data from the sensor, control a transceiver to send a first signal representing the performance parameter to a server; and
receive a second signal representing instructions from the server;
wherein the instructions are generated in response to the performance parameter.

20. The robot of claim 19, wherein the processor is further configured to control an actuator to perform a task in accordance with the instructions.
